(19) United States
(12) Patent Application Publication
(10) Pub. No.: US 2008/0146267 A1
(43) Pub. Date: Jun. 19, 2008

(54) ACCESS MANAGEMENT TECHNIQUES FOR COMMUNICATIONS DEVICES

(75) Inventors: Jerome C. Tu, Saratoga, CA (US); Jianxiong Shi, Pleasonton, CA (US)

Correspondence Address: KACVINSKY LLC;C/O INTELLEVATE, P.O. BOX 52050, MINNEAPOLIS, MN, 55402, US

(73) Assignee: PALM, INC., Sunnyvale, CA (US)

(21) Appl. No.: 11/611,474

(22) Filed: Dec. 15, 2006

(51) Int. Cl. H04M 1/00

(52) U.S. Cl. 455/551

(57) ABSTRACT

Techniques involving network access are disclosed. For example, an apparatus may include multiple radio modules that may each communicate according to a corresponding wireless access technology. The apparatus may further include a storage medium and an access coordination module. Multiple consolidated access profiles may be stored by the storage medium. Each of these consolidated access profiles may correspond to a locality and may include individual network access parameters or profiles for each radio module. Based on an assessed locality of the apparatus, the access coordination module may select a consolidated access profile, and provide associated information to the multiple radio modules. This associated information may include (or point to) individual network access profiles or parameters. Thus, from this information, the radio modules may identify and acquire networks in a streamlined manner.

### BACKGROUND

Mobile computing devices, such as smart phones, may provide various processing capabilities. For example, mobile devices may provide personal digital assistant (PDA) features, including word processing, spreadsheets, synchronization of information (e.g., e-mail) with a desktop computer, and so forth.

In addition, such devices may have wireless communications capabilities. More particularly, mobile devices may employ various communications technologies to provide features, such as mobile telephony, mobile e-mail access, web browsing, and content (e.g., video and radio) reception. Exemplary wireless communications technologies include cellular, satellite, and mobile data networking technologies.

To provide wireless capabilities, such devices may include one or more radio modules. Due to the mobility of such devices, these radio modules perform scanning or searching operations to locate available networks (e.g., to find access points or cellular base stations).

Unfortunately, a substantial amount of time may be spent scanning or searching before appropriate networks are acquired. Accordingly, techniques to reduce delays in network acquisition are desired.

### BRIEF DESCRIPTION OF THE DRAWINGS

FIG. 1A illustrates an embodiment of an apparatus.

FIG. 1B illustrates a further embodiment of an apparatus.

FIG. 2 is a diagram of exemplary consolidated access profiles.

FIG. 3 illustrates one embodiment of a logic diagram.

FIG. 4 illustrates one embodiment of a system.

### DETAILED DESCRIPTION

Various embodiments may be generally directed to techniques for coordinating network access in communications devices. For instance, an apparatus may include multiple radio modules that may each communicate according to a corresponding wireless access technology. The apparatus may further include a storage medium and an access coordination module. Multiple consolidated access profiles may be stored by the storage medium. Each of these consolidated access profiles may correspond to a locality and may include individual network access parameters or profiles for each radio module. Based on an assessed locality of the apparatus, the access coordination module may select a consolidated access profile, and provide associated information to the multiple radio modules. This associated information may include (or point to) individual network access profiles or parameters. Thus, from this information, the radio modules may identify and acquire networks in a streamlined manner.

Accordingly, individual network access parameters or profiles within the same consolidated network access profile are considered to be “cross-referenced”. Through such cross-referencing, faster (and more accurate) network acquisition may occur. Also, acquisition or registration with unwanted networks may be lessened. As a result, user experience may be enhanced.

Embodiments of the present invention may involve a variety of wireless communications technologies. These technologies may include cellular and data networking systems. Exemplary data networking systems include wireless local area networks (WLANs), wireless metropolitan area networks (WMANs), and personal area networks (PANs).

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include other combinations of elements in alternate arrangements as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

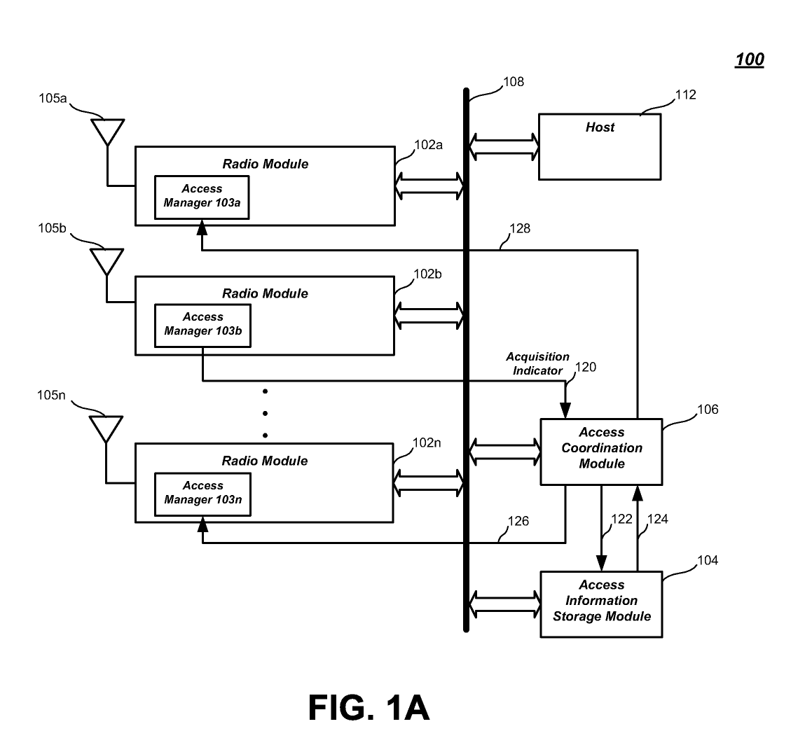

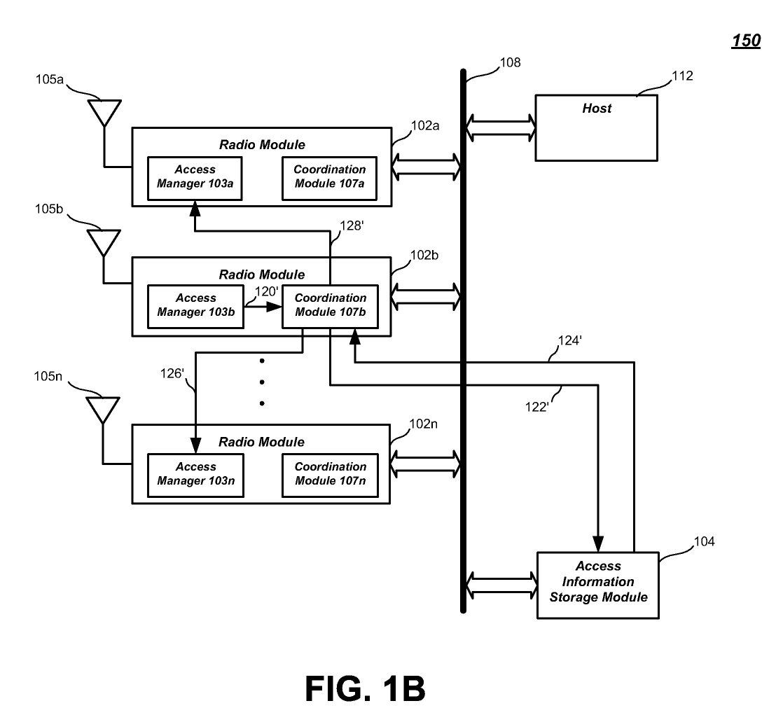

FIG. 1A illustrates one embodiment of an apparatus that may communicate across wireless links. In particular, FIG. 1A shows an apparatus 100 comprising various elements. The embodiments, however, are not limited to these depicted elements. FIG. 1A shows that apparatus 100 may include multiple radio modules 102a-n, an access information storage module 104, an access coordination module 106, and an interconnection medium 108. These elements may be implemented in hardware, software, firmware, or in any combination thereof.

Each radio module 102 may provide for communications with remote devices across wireless networks or links. Thus, each radio module 102 may include electronics to transmit and/or receive wireless signals. Such electronics may include modulators, demodulators, amplifiers, filters, and so forth.

Radio modules 102 may provide for communications across various types of wireless links. For example, a radio module 102 may communicate across data networking links. Examples of such data networking links include wireless local area network (WLAN) links, such as IEEE 802.11 WiFi links. Further examples include wireless metropolitan area (WMAN) links, such as IEEE 802.16 WiMax links and IEEE 802.16e WiBro links. Yet further examples include WiMedia/Ultra Wide Band (UWB) links (e.g., ones in accordance with Ecma International standards ECMA-368 and ECMA-369). Also, exemplary data networking links include personal area networks (PAN) links such as Bluetooth links, and WiBree (initially developed by Nokia Research Centre) links. The embodiments, however, are not limited to these examples.

Alternatively or additionally, a radio module 102 may communicate across wireless links provided by one or more cellular systems. Exemplary cellular systems include Code Division Multiple Access (CDMA) systems, Global System for Mobile Communications (GSM) systems, North American Digital Cellular (NADC) systems, Time Division Multiple Access (TDMA) systems, Extended-TDMA (E-TDMA) systems, Digital Advanced Mobile Phone Service (IS-136/TDMA) systems, Narrowband Advanced Mobile Phone Service (NAMPS) systems, third generation (3G) systems such as Wide-band CDMA (WCDMA), CDMA-2000, Universal Mobile Telephone System (UMTS), cellular radiotelephone systems compliant with the Third-Generation Partnership Project (3GPP), and so forth. However, the embodiments are not limited to these examples. For example, various 4G systems may be employed.

Each radio module 102 may include an access manager 103. More particularly, FIG. 1A shows radio modules 102a-n including access managers 103a-n, respectively. Each access manager 103 may perform various operations. Such operations may involve, for example, the identification of available wireless networks for the corresponding radio module 102. This identification may involve various scanning procedures. Further, when multiple networks are available to a radio module 102, its access manager 103 may select one of these networks for acquisition.

Apparatus 100 provides for the coordination of information among radio modules 102 regarding the access or acquisition of networks. As a result of this coordination, activities (such as scanning and network acquisition) may be streamlined.

Access information storage module 104 and access coordination module 106 may operate to provide this coordination of information among radio modules 102. For instance, access information storage module 104 may store network access information for each of radio modules 102a-n. This information may be arranged into one or more consolidated access profiles, where each consolidated access profile corresponds to a particular location or locality. The consolidated access profiles for a particular location or locality may each include access information for one or more of radio modules 102 to acquire particular networks (e.g., preferred networks).

Such access information may be arranged in the form of individual network access profiles, each including one or more access parameters. Exemplary access parameters include frequency channels and network identifiers. However, the embodiments are not limited to such.

Access coordination module 106 may select a consolidated access profile from access information storage module 104. This selection may be based on an assessment of the locality of apparatus 100. Once this selection occurs, access coordination module 106 may provide one or more of radio modules 102 with network access parameters or profiles from the selected consolidated access profile.

FIG. 1A shows that apparatus 100 may further include a host 112, which may exchange information with radio modules 102a-n. Such exchanges may occur across interconnection medium 108. For instance, host 112 may send information to these radio modules for wireless transmission. Conversely, radio modules 102a-n may send information to host 112 that was received in wireless transmissions. In addition, host 112 may exchange information with radio modules 102a-n regarding their configuration and operation. Examples of such information include control directives issued by host 112.

Furthermore, host 112 may perform operations associated with one or more protocols (e.g., multiple protocols at various layers). Additionally, host 112 may perform operations associated with user applications. Exemplary user applications include telephony, text messaging, e-mail, web browsing, word processing, and so forth. Moreover, host 112 may provide one or more functional utilities that are available to various protocols, operations, and/or applications. Exemplary utilities include operating systems, device drivers, user interface functionality, and so forth.

Interconnection medium 108 provides for couplings among elements, such as radio module 102 and host 112. Thus, interconnection medium 108 may include, for example, one or more bus interfaces. Exemplary interfaces include Universal Serial Bus (USB) interfaces, as well as various computer system bus interfaces. Additionally or alternatively, interconnection medium 108 may include one or more point-to-point connections (e.g., parallel interfaces, serial interfaces, etc.) between various element pairings. In embodiments, interconnection medium 108 may provide for the exchange of access information, as described herein.

In general operation, apparatus 100 may engage in wireless communications with various types of networks. In addition, apparatus 100 may coordinate access information among radio modules 102 based on an assessment of its locality.

FIG. 1A provides an illustrative example of locality assessment and access information distribution. This example involves access coordination activities based on a network acquisition by radio module 102b. However, similar activities may be based on acquisitions by other radio modules.

Each of radio modules 102 may send indications of their network acquisitions to access coordination module 106. For example, FIG. 1A shows radio module 102b sending an acquisition indicator 120 to access coordination module 106. Acquisition indicator 120 may include various types of information. For example, acquisition indicator 120 may include an identifier of the originating radio module 102. In addition, acquisition indicator 120 may include one or more network access parameters. Examples of network access parameters include an identifier or address of the acquired network, frequency channel information, and/or other information.

Upon receipt of acquisition indicator 120, access coordination module 106 assesses the locality of apparatus 100. This may involve access coordination module 106 searching access information storage module 104 to identify a particular consolidated access profile corresponding to the information provided by acquisition indicator 120.

As shown in FIG. 1A, identifying this consolidated access profile may involve the exchange of one or more access requests 122 and data retrievals 124 between access coordination module 106 and access information storage module 104.

Once access coordination module 106 identifies a particular consolidated access profile, it may distribute associated information to radio modules 102. For instance, FIG. 1A shows access coordination module 106 sending a message 126 to radio module 102n and a message 128 to radio module 102a. These messages may be received within the access managers 103 of these radio modules.

Messages 126 and 128 may convey various types of information. For instance, these messages may convey individual access parameters or profiles. Alternatively, these messages may indicate the identified consolidated access profile.

Upon receipt of messages 126 and 128, radio modules 102a and 102n may each select and acquire a corresponding network. Such networks may be desired or preferred for the assessed locality. In cases where messages 126 and 128 convey consolidated access profile indicators (instead of individual access parameters or profiles), these actions may involve radio modules 102a and 102n accessing the corresponding individual access parameters or profiles from access information storage module 104.

As described above, the coordination of access information may streamline network acquisition. For example, in the context of scanning operations, a radio module 102 may use received access parameters or profiles to select a preferred network over other available networks. Without the received access information, the radio module 102 would possibly select from the other less-preferred networks using locality-agnostic techniques (e.g., selection according to signal strength).

Also, a radio module 102 may use received access parameters to initiate scanning operations. This feature may advantageously conserve operational power by shortening scanning durations. Such initiated scanning operations may be active instead of passive. More particularly, through active scanning, the radio module 102 transmits “probe” messages instead of “passively” listening for network-identifying transmissions. Such probe messages solicit responses identifying networks within communicating range. If a response is received that provides a matching network access profile, access parameter(s), and/or network characteristic(s), then the radio module 102 may acquire the network.

An example of a further apparatus embodiment is shown in FIG. 1B. In particular, FIG. 1B shows an apparatus 150, which is similar to apparatus 100. However, apparatus 150 does not include access coordination module 106. Instead, each of radio modules 102a-n includes a coordination module 107. For instance, FIG. 1B shows radio module 102a including a coordination module 107a, radio module 102b including a coordination module 107b, and radio module 102n including a coordination module 107n.

Each coordination module 107 may perform locality assessment and distribute access information. For example, FIG. 1B shows coordination module 107b receiving an acquisition indicator 120′ from access manager 103b. Like acquisition indicator 120, acquisition indicator 120′ indicates that radio module 102b has acquired a network. Accordingly, acquisition indicator 120′ may include information, such as one or more network access parameters.

Upon receipt of indicator 120′, coordination module 107b may identify a corresponding consolidated access profile through the exchange of one or more access requests 122′ and data retrievals 124′ with access information storage module 104. Once a consolidated access profile is identified, coordination module 107b distributes messages 126′ and 128′ to radio modules 102n and 102a, respectively. These messages may convey various types of information. For instance, this information may convey individual access parameters or profiles. Alternatively, this information may indicate the identified consolidated access profile.

Upon receipt of messages 126′ and 128′, radio modules 102a and 102n may each select and acquire a corresponding network. Such networks may be desired or preferred for the assessed locality. In cases where messages 126′ and 128′ convey consolidated access profile indicators (instead of individual access parameters or profiles), these actions may involve accesses the corresponding individual access parameters or profiles from access information storage module 104.

As described above, FIGS. 1A and 1B provide exemplary apparatus arrangements. However, the embodiments are not limited to these arrangements. For instance, embodiments may include any number of radio modules. Also, radio modules 102a-n may each include a storage medium to contain a local copy of access information storage module 104.

Further, FIGS. 1A and 1B show host 112 being coupled to one or more radio modules via interconnection medium 108. However, embodiments may include other arrangements. For example, embodiments may not include a separate host. Also, embodiments may provide an integrated host/radio architecture. In such embodiments, features of a host and one or more radio modules may be implemented together in a single entity, such as a processor or package. Accordingly, a single processor (or processing entity) may provide features of host 112 and radio modules 102. Thus, interconnection medium 108 may be non-physical. More particularly, such interconnectivity may be implemented through messages passed between processes or software modules.

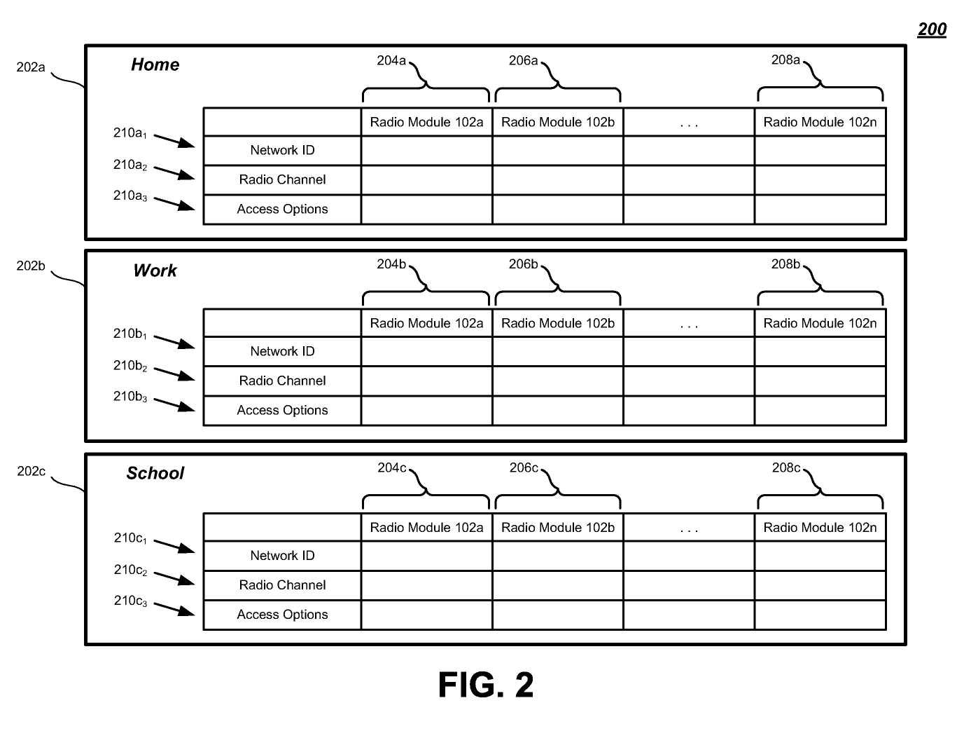

FIG. 2 is a diagram 200 of exemplary consolidated access profiles. With reference to FIGS. 1A and 1B, these profiles may be stored in access information storage module 104. In particular, FIG. 2 shows consolidated access profiles 202a-c. Each of these consolidated access profiles corresponds to a particular location. For the purposes of illustration, FIG. 2 shows consolidated access profile 202a corresponding to a home location, consolidated access profile 202b corresponding to a work location, and consolidated access profile 202c corresponding to a school location.

Each consolidated access profile 202 is illustrated as a table that provides access parameters for individual radios. With reference to FIGS. 1A and 1B, each of these tables includes a column 204 for radio module 102a, a column 206 for radio module 102b, and a column 208 for radio module 102n.

Further, each of these tables includes multiple rows 210. These rows correspond to particular network access parameters. Exemplary parameters include network ID, radio channel, and access options. For a particular column, these rows, when combined, may provide an individual network access profile.

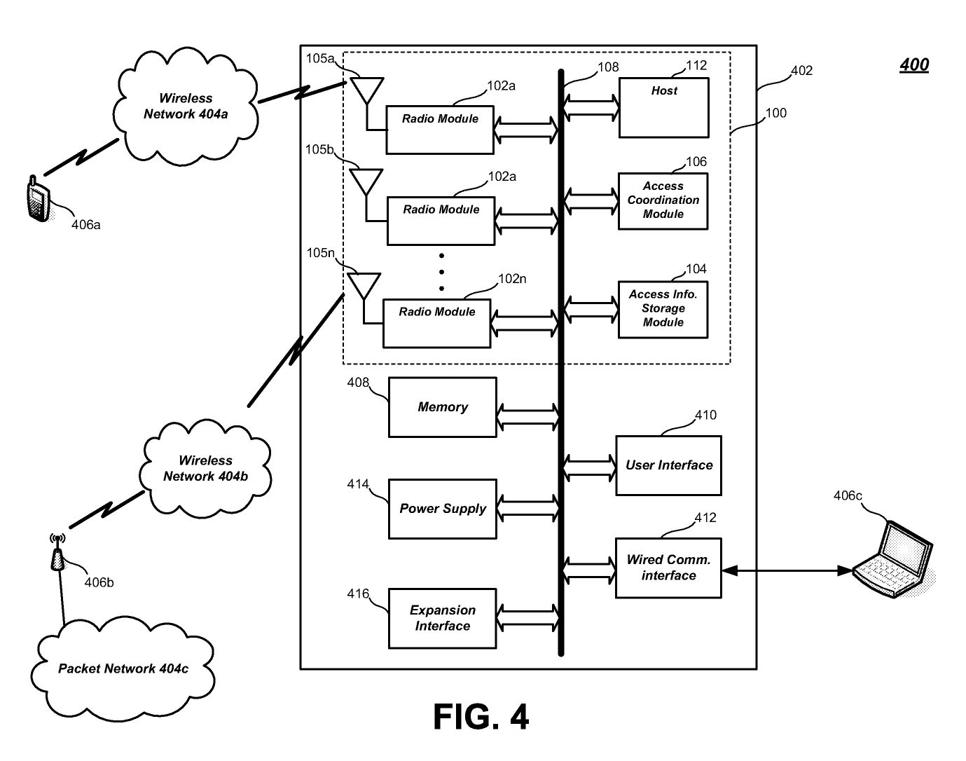

In embodiments, consolidated access profiles, such as the exemplary ones of FIG. 2, may be generated or modified by a user. For example, a user may create consolidated access profiles and populate them with parameter values according to his or her preferences. Such activities may involve the user interacting with a user interface. Exemplary user interfaces are described below with reference to FIG. 4.

Moreover, such techniques may involve automatically populating a consolidated access profile with access parameters. For example, a user at a certain location may decide to generate a consolidated profile for the location. At this point, information for all visible, currently connected networks may be automatically entered into the consolidated profile.

In further embodiments, storage of consolidated access profiles may be performed by wireless network operators, such as operators of cellular or data networks. Thus, such operators may populate access information storage modules with certain values. For a particular device or apparatus, such populating may performed upon or before its purchase. This is also referred to as pre-populating. Alternatively, network operators may perform such populating when a device or apparatus acquires or registers with a wireless network. In such cases, populating may involve downloading information according to various operator “push” or user-initiated “pull” modes.

Network operators may select access profiles for populating that encourages registration or acquisition of networks operated by “partner” providers. For example, a cellular network provider may populate an apparatus with access profiles or parameters that encourage acquiring data networks of certain partner providers.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented, unless otherwise indicated. In addition, the given logic flow may be implemented by a hardware element, a software element executed by a processor, or any combination thereof. The embodiments are not limited in this context.

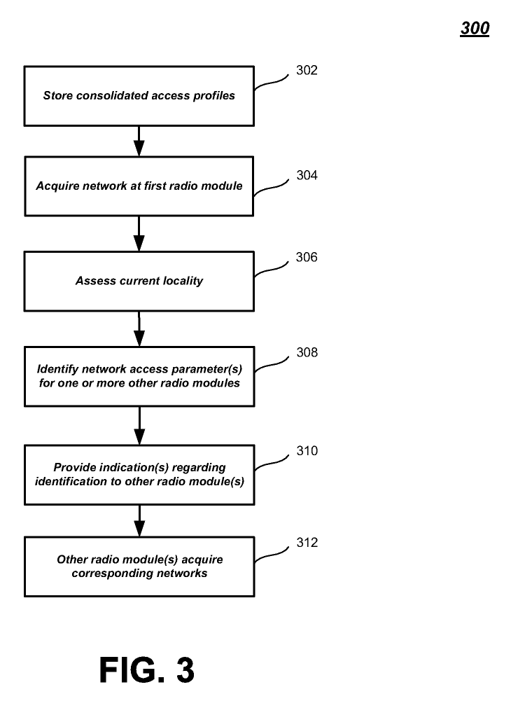

FIG. 3 illustrates one embodiment of a logic flow. In particular, FIG. 3 illustrates a logic flow 300, which may be representative of the operations executed by one or more embodiments described herein.

As shown in logic flow 300, a block 302 stores one or more consolidated access profiles. This may also involve updating existing (or currently stored) consolidated access profiles. Each consolidated access profile may correspond to a location or locality and may include network access parameters for multiple radio modules. With reference to FIGS. 1A and 1B, these consolidated access profiles may be stored in access information storage module 104.

In embodiments, the storage of consolidated access profiles may be performed based on user inputs. As described above with reference to FIG. 2, consolidated access profiles may be generated or modified by a user, for example, through interaction with a user interface. Further, this may involve automatically populating a consolidated access profile with access parameters based on networks that are visible and/or connected at a present location. Moreover, consolidated access profiles may be generated or modified by wireless network operators. As described above, this may involve pre-populating or downloading information. Such operator-provided profiles may encourage registration or acquisition of networks operated by “partner” providers.

FIG. 3 shows that a block 304 acquires a network at a first radio module. Based on this acquisition, a block 306 assesses a current locality. This assessment may involve searching the consolidated access profiles stored by block 302. More particularly, this may involve identifying a consolidated access profile that indicates attributes of the network acquired by the first radio module.

From this current locality, a block 308 identifies one or more network access parameters for one or more other radio modules. This may involve identifying one of the stored consolidated access profiles.

Upon this identification, a block 310 sends indication(s) to the one or more other radio modules. These indications may include various forms of information, such as an identifier of the consolidated access profile or individual network access parameter(s) for each of the other radio modules.

Following this, the one or more other radio modules may acquire networks in block 312. These acquisitions may be in accordance with the information sent by block 310.

FIG. 4 illustrates an embodiment of a system 400. This system may be suitable for use with one or more embodiments described herein, such as apparatus 100, apparatus 150, logic flow 300, and so forth. Accordingly, system 400 may engage in wireless communications across various link types, such as the ones described herein. In addition, system 400 may perform various user applications.

As shown in FIG. 4, system 400 may include a device 402, multiple communications networks 404, and one or more remote devices 406. FIG. 4 shows that device 402 may include the elements of FIG. 1A. However, device 402 may alternatively include the elements of FIG. 1B, as well as elements of other embodiments. As described above, such other embodiments may involve integrated host/radio architectures.

Also, device 402 may include a memory 408, a user interface 410, a wired communications interface 412, a power supply 414, and an expansion interface 416. These elements may be implemented in hardware, software, firmware, or any combination thereof.

Memory 408 may store information in the form of data. For instance, memory 408 may contain application documents, e-mails, sound files, and/or images in either encoded or unencoded formats. Alternatively or additionally, memory 408 may store control logic, instructions, and/or software components. These software components include instructions that can be executed by one or more processors. Such instructions may provide functionality of one or more elements in system 400. Exemplary elements include host 112, one or more components within radio modules 102a-n, access coordination module 106, user interface 410, and/or communications interface 412.

Memory 408 may be implemented using any machine-readable or computer-readable media capable of storing data, including both volatile and non-volatile memory. For example, memory 408 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 408 may be included in other elements of system 400. For instance, some or all of memory 408 may be included on a same integrated circuit or chip with elements of apparatus 100 and/or apparatus 150. Alternatively some portion or all of memory 408 may be disposed on an integrated circuit or other medium, for example a hard disk drive, which is external. The embodiments are not limited in this context.

User interface 410 facilitates user interaction with device 402. This interaction may involve the input of information from a user and/or the output of information to a user. Accordingly, user interface 410 may include one or more devices, such as a keyboard (e.g., a full QWERTY keyboard), a keypad, a touch screen, a microphone, and/or an audio speaker.

Wired communications interface 412 provides for the exchange of information with a device 406c (e.g., a proximate device), such as a personal computer. This exchange of information may be across one or more wired connections. Examples of such connections include USB interfaces, parallel interfaces, and/or serial interfaces. In addition, interface 412 may provide for such exchanges across wireless connections(s). An infrared interface is an example of such a connection. The information exchanged with such proximate devices, may include e-mail, calendar entries, contact information, as well as other information associated with personal information management applications. In addition, such information may include various application files, and content (e.g., audio, image, and/or video).

Wired communications interface 412 may include various components, such as a transceiver and control logic to perform operations according to one or more communications protocols. In addition, communications interface 412 may include input/output (I/O) adapters, physical connectors to connect the I/O adapter with a corresponding communications medium.

FIG. 4 shows that device 402 may communicate across wireless networks 404a and 404b. In particular, FIG. 4 shows communications across network 404a being handled by radio module 102a, and communications across network 404b being handled by radio module 102n. First wireless network 404a may be a cellular network, while second wireless network 404b may be a wireless data network. However, the embodiments are not limited to these examples. Moreover, while not depicted, radio module 102b may also communicate across a wireless network.

Such wireless communications allow device 402 to communicate with various remote devices. For instance, FIG. 4 shows device 402 engaging in wireless communications (e.g., telephony or messaging) with a mobile device 406a. In addition, FIG. 4 shows device 402 engaging in wireless communications (e.g., WLAN, WMAN, and/or PAN communications) with an access point 406b. In turn, access point 406b may provide device 402 with access to further communications resources. For example, FIG. 4 shows access point 406b providing access to a packet network 404c, such as the Internet.

Power supply 414 provides operational power to elements of device 402. Accordingly, power supply 414 may include an interface to an external power source, such as an alternating current (AC) source. Additionally or alternatively, power supply 414 may include a battery. Such a battery may be removable and/or rechargeable. However, the embodiments are not limited to these examples.

Expansion interface 416 may be in the form of an expansion slot, such as a secure digital (SD) slot. Accordingly, expansion interface 416 may accept memory, external radios (e.g., global positioning system (GPS), Bluetooth, WiFi radios, etc.), content, hard drives, and so forth. The embodiments, however, are not limited to SD slots. Other expansion interface or slot technology may include memory stick, compact flash (CF), as well as others.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a plurality of radio modules, each radio module to communicate according to a corresponding wireless access technology;
a storage medium to store a plurality of consolidated access profiles, wherein each consolidated access profile corresponds to a locality and includes individual network access profiles for each of the plurality of radio modules; and
an access coordination module to select one of the consolidated access profiles based on a locality assessment of the apparatus, and to indicate the selection to one or more of the plurality of radio modules.

2. The apparatus of claim 1, wherein the access coordination module is to perform the locality assessment of the apparatus.

3. The apparatus of claim 2, wherein the access coordination module is to perform the locality assessment of the apparatus based on the identity of a wireless network acquired by one of the radio modules.

4. The apparatus of claim 1, wherein the access coordination module is to indicate the selection with an identifier of the selected consolidated access profile.

5. The apparatus of claim 1, wherein the access coordination module is to indicate the selection with individual network access profiles from the selected consolidated access profile.

6. The apparatus of claim 1, wherein each individual network access profile comprises one or more access parameters, the one or more access parameters including a frequency channel and/or a network identifier.

7. An apparatus, comprising:
a plurality of radio modules, each radio module to communicate according to a corresponding wireless access technology; and
a storage medium to store a plurality of consolidated access profiles, wherein each consolidated access profile corresponds to a locality and includes one or more network access parameters for each of the plurality of radio modules;
wherein each of the radio modules is to, upon acquisition of a network, select one of the consolidated access profiles corresponding to the network, and indicate the selection to the other radio modules.

8. The apparatus of claim 7, wherein the one or more access parameters includes a frequency channel and/or a network identifier.

9. A method, comprising:
acquiring a first network at a first radio module;
assessing a current locality based on the first network;
identifying one or more network access parameters for a second radio module, the one or more network access parameters corresponding to the current locality; and
informing the second radio module of said identification.

10. The method of claim 9, wherein said informing comprises sending the one or more access parameters to the second radio module.

11. The method of claim 9, further comprising:
acquiring a second network at the second radio module in accordance with the one or more network access parameters.

12. The method of claim 9, wherein the one or more network access parameters include a frequency channel and/or a network identifier.

13. The method of claim 9, further comprising:
storing a first access profile for the first radio module, the first access profile associated with the first network;
storing a second access profile for the second radio module, the second access profile comprising the one or more network access parameters; and
storing a correspondence between the current location and the first and second access profiles.

14. The method of claim 13, wherein said storing the first access profile, said storing the second access profile, and said storing the correspondence are initiated by a user.

15. The method of claim 13, wherein said storing the first access profile, said storing the second access profile, and said storing the correspondence are initiated by a network operator.

16. The method of claim 9, further comprising:
storing a plurality of consolidated access profiles, wherein each consolidated access profile corresponds to a locality and includes network access parameters for the first and second radio modules;
wherein assessing the current locality based on the first network comprises determining one of the consolidated access profiles corresponding to one or more access parameters of the first network.

17. The method of claim 16, wherein said storing is initiated by a user.

18. The method of claim 16, wherein said storing is initiated by a network operator.

19. An apparatus, comprising:
a plurality of radio modules, each radio module to communicate according to a corresponding wireless access technology;
a storage medium to store a plurality of consolidated access profiles, wherein each consolidated access profile corresponds to a locality and includes network access parameters for each of the plurality of radio modules;
a controller to, upon acquisition of a network by one of the radio modules, select a corresponding consolidated access profile associated with the network.

20. The apparatus of claim 15, wherein the controller is to indicate the selection to the remaining of the plurality of radio modules.

21. An article comprising a machine-readable storage medium containing instructions that if executed enable a system to:
acquire a first network at a first radio module;
assess a current locality based on the first network;
identify one or more network access parameters for a second radio module, the one or more network access parameters corresponding to the current locality; and
inform the second radio module of said identification.
